(19) United States
(12) Patent Application Publication
(10) Pub. No.: US 2026/0049633 A1
(43) Pub. Date: Feb. 19, 2026

(54) SEALING CONNECTOR

(71) Applicant: Illinois Tool Works Inc., Glenview, IL (US)

(72) Inventor: Joshua Goring, Brighton (GB)

(21) Appl. No.: 19/101,707

(22) PCT Filed: Aug. 8, 2023
(86) PCT No.: PCT/US2023/071848

§ 371 Date: Feb. 6, 2025

(30) Foreign Application Priority Data
Aug. 10, 2022 (GB) 2211672.7

(51) Int. Cl. F16B 43/00

(52) U.S. Cl. CPC F16B 43/001

(57) ABSTRACT

A sealing connector for mounting a component and a membrane to a structure.

### PRIORITY CLAIM

This application claims priority to and the benefit of Great Britain Application No. 2211672.7, which was filed on Aug. 10, 2022, the entire contents of which is incorporated herein by reference.

The invention relates generally to a sealing connector. In particular, the invention relates to a sealing connector for mounting a component and a membrane to a structure.

### BACKGROUND

When a component is to be fixed to a separate structure, a fastener is often provided and inserted through both the component to be fixed and the structure, to fix the component in place. For example, a bracket may be mounted to the outside of a concrete wall. In examples such as these, it is particularly important to prevent a liquid such as water from entering the inside of the concrete wall from the outside.

A known example of a fastener assembly used to fasten a bracket to a wall is shown in FIG. 1. The fastener assembly 2 includes a fastener 4 with a shank 6 on a proximal side having a number of engagement portions 8 integrated with and protruding outwards away from the shank 6. The distal side of the fastener 2 is provided with a head 10. To fasten the bracket to the wall, apertures in the bracket and wall are aligned, and then the shank 8 of the fastener 4 is inserted through those aligned apertures. When inserted, the engagement portions 8 engage the edges of the bracket and wall apertures. If no seal is provided, then any liquid such as water can seep from the outside (i.e. bracket side) to the inside of the wall. As such, the fastener assembly 2 is provided with a sealing washer 50 onto the shank 8 and abutting the head 10 such that when the fastener assembly 2 is inserted into the apertures of the bracket and wall, the sealing washer 50 fills in any gaps between the bracket, fastener 4 and wall.

The sealing washer 50 is shown in more detail in FIG. 2. The sealing washer 50 includes a larger annular portion 56 that engages the head 10 of the fastener, and a smaller annular portion 52 that engages the wall. The sealing washer 50 includes a through-aperture 54 extending through the thickness of the washer 50, that receives the shank 8 of the fastener 4.

In order to fasten a component to a structure using the fastener assembly 2, drilling is required to create apertures in both the component and the structure, in order to facilitate the fixation of the fastener assembly 2. In addition, hammering is typically required to secure the fastener assembly 2 in place. Both of these process steps are slow, labour-intensive and produce dust that affect the sealing characteristics of the fastener assembly 2.

It would be desirable to provide a sealing connector that addresses these problems. Particularly, it is an object of the invention to provide a sealing connector that improves the efficiency and simplicity of mounting a component to a structure. It is another object of the invention to provide a sealing connector that can be used to mount a component to a structure in a waterproof way, that does not involve drilling or hammering. It is a further object of the invention to provide a sealing connector with improved sealing.

The present invention provides at least an alternative to sealing connectors of the prior art.

### SUMMARY OF THE INVENTION

In accordance with the present invention there is provided a sealing connector according to the appended claims.

According to an aspect of the present invention, there is provided a sealing connector for mounting a component and a membrane to a structure, comprising:
a membrane fixing portion comprising an opening for a nail such that the sealing connector can be nailed to the structure with the membrane in between, and
a component mounting portion extending from the membrane fixing portion and adapted for fixing of the component thereto.

Thus, the sealing connector and membrane can be prefixed to the structure and held in place, and then a component can be subsequently mounted onto the sealing connector. This allows a component to be mounted more efficiently and in a simpler manner, without penetrating the membrane. More particularly, by providing a sealing connector with a membrane fixing portion in the claimed manner, the sealing connector can be prefixed into the structure and subsequently a component can be mounted, each without requiring drilling and hammering. Drilling and hammering are slow and laborious process steps that produce a significant amount of dust. By providing a sealing connector that can mount a component and membrane to a structure without drilling and hammering, the sealing connector can mount a component and membrane to a structure more quickly, less labour-intensively and in a way that produces less dust, therefore improving sealing.

In some embodiments, the sealing connector is for mounting a component and a membrane to a structure made of concrete.

Advantageously, in some embodiments, the membrane fixing portion of the sealing connector is configured to seal against the membrane.

Advantageously, in some specific embodiments, the membrane fixing portion is resiliently deformable against the membrane.

Advantageously, in some embodiments, the membrane fixing portion comprises a sealing member.

In some embodiments, the sealing member has an annular shape.

Advantageously, in some embodiments, at least a portion of the membrane fixing portion is shaped and sized corresponding to a recess of the membrane.

Advantageously, in some embodiments, the membrane fixing portion has a frustoconical shape.

Advantageously, in some embodiments, the membrane fixing portion has a profile that tapers in shape towards the membrane.

Advantageously, in some specific embodiments, the membrane fixing portion comprises a recessed surface configured for receiving a sealing washer.

In some embodiments, the component mounting portion comprises a fastener-receiving aperture, configured to receive a fastener for affixing the component to the sealing connector.

In some embodiments, the fastener is a screw.

In some embodiments, the fastener-receiving aperture comprises a first central axis.

In some specific embodiments, the opening of the membrane fixing portion comprises a second central axis parallel to the first central axis.

According to another aspect of the present invention, there is provided a membrane, for sealingly receiving a sealing connector, comprising:
a front surface arranged to face the sealing connector, and a rear surface arranged to face the structure, and
at least one recess formed in the front surface, the recess being shaped to receive the membrane fixing portion of the sealing connector.

Advantageously, in some embodiments, at least one recess comprises a frustoconical profile.

Advantageously, in some embodiments, at least one recess has a profile that tapers in shape towards the structure.

In some embodiments, the front surface comprises an array of recesses.

In some embodiments, the array of recesses comprises a plurality of rows of recesses and a plurality of columns of recesses. In some embodiments, the number of rows and columns of recesses are equal.

In some specific embodiments, each recess of the array of recesses are equidistantly spaced about the front surface.

In some specific embodiments, at least one recess of the array of recesses is aligned with at least one adjacent recess along the plane of the front surface in a vertical direction.

In some specific embodiments, each recess within at least one column of recesses is aligned along the plane of the front surface in a vertical direction.

In some specific embodiments, at least one recess of the array of recesses is aligned with at least one adjacent recess along the plane of the front surface in a horizontal direction.

In some specific embodiments, each recess within at least one row of the recesses is aligned along the plane of the front surface in a horizontal direction.

According to a further aspect of the present invention, there is provided a sealing connector assembly for mounting a component to a structure, comprising a sealing connector and a membrane.

According to another aspect of the present invention, there is provided a method of mounting the membrane to a structure using the sealing connector, comprising the steps of:
nailing the membrane fixing portion of the sealing connector to the membrane, with the membrane in between the sealing connector and the structure, and
mounting the component to the component mounting portion of the sealing connector.

In some embodiments, the step of mounting the component to the component mounting portion comprises inserting a fastener into the component mounting portion.

In some embodiments, the step of inserting a fastener into the component mounting portion does not pierce the membrane.

In some embodiments, the step of mounting the component to the component mounting portion comprises inserting a screw into the component mounting portion.

In some embodiments, the method is for mounting the membrane to a structure made of concrete, using the sealing connector.

### BRIEF DESCRIPTION OF THE DRAWINGS

Embodiments of the invention are now described, by way of example only, hereinafter with reference to the accompanying drawings, in which:

FIG. 1 illustrates a known fastener assembly including a fastener and a sealing washer;

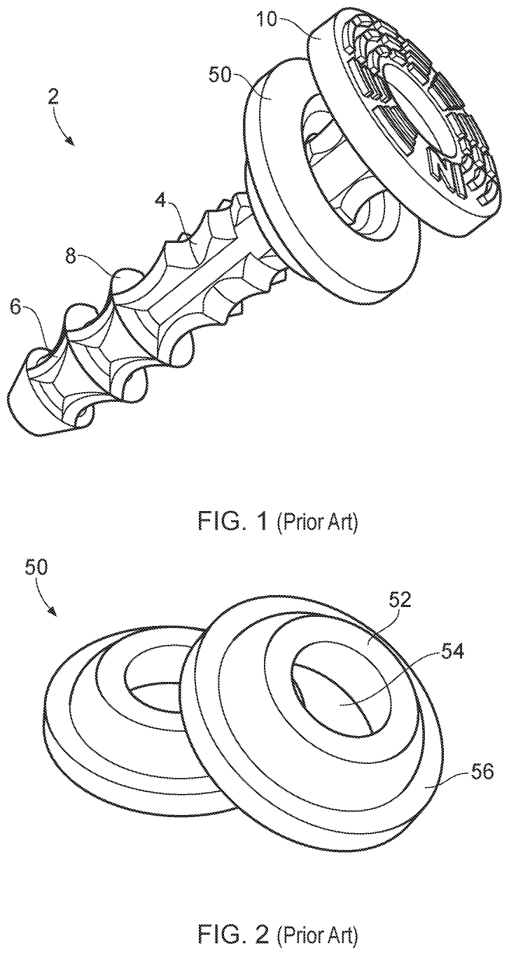

FIG. 2 illustrates known sealing washers of the fastener assembly of FIG. 1;

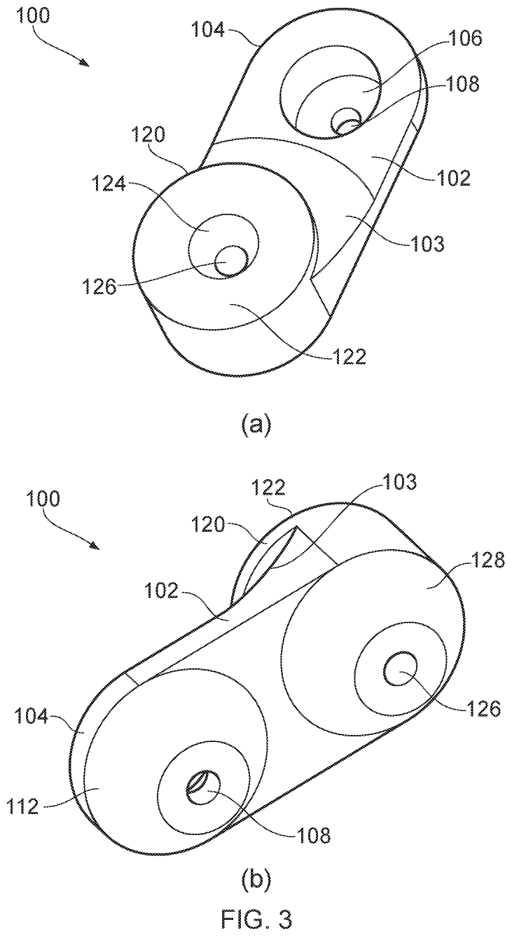

FIG. 3 illustrates a sealing connector: (a) from a perspective top view, (b) from a perspective bottom view, (c) from a top profile view, (d) from a bottom profile view, and (e) from a side profile view;

FIG. 4 illustrates a sealing member: (a) from a perspective view, and (b) from a top profile view; and

FIG. 5 illustrates a schematic diagram showing the mounting of a membrane to a structure using a sealing connector.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centreline or a geometric centre of an element being described (e.g. central axis), the particular meaning being readily apparent from the context of the description. Further, as used herein, the terms ‘connected’, ‘attached’, ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

Like reference numerals are used to depict like features throughout.

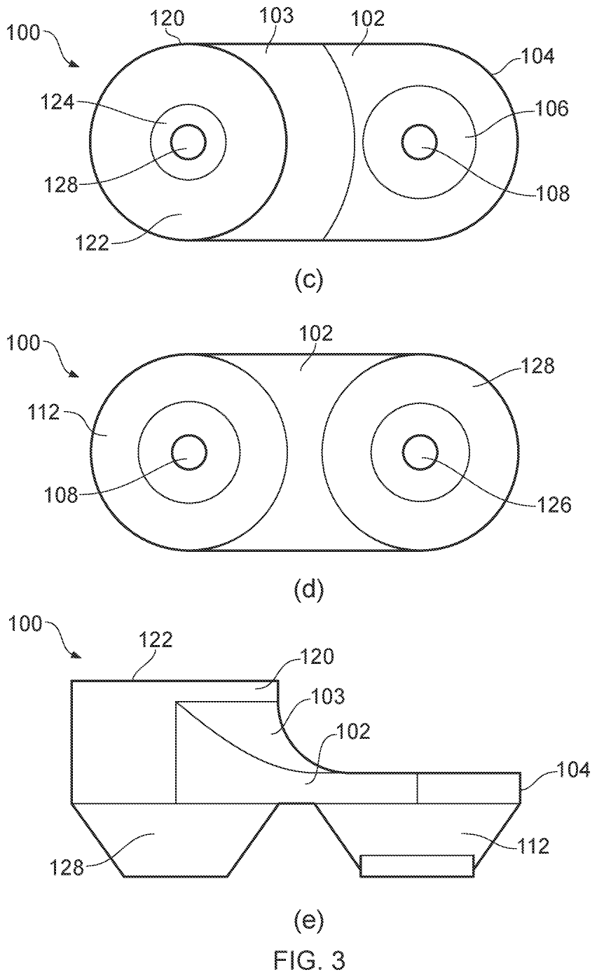

Referring now to FIG. 3, there is shown a sealing connector 100. The sealing connector 100 has a body 102 with a membrane fixing part 104 and a component mounting part 120 that extends from the membrane fixing part 104. The membrane fixing part 104 and the component mounting part 120 are integral, specifically integrally formed with one another on the body 102 as a single unit. In this example, a ramping surface 103 extends between the membrane fixing part 104 and the component mounting part 120, as best shown in FIG. 3(e). The ramping surface 103 ramps upwards from the membrane fixing part 104 towards the component mounting part 120.

The membrane fixing part 104 is provided with an opening 108 that extends through to a rear surface. In this example, the membrane fixing part 104 has a recessed portion 106 that is circular, and the opening 108 is provided from the back surface of the recessed portion 106 to the rear surface of the membrane fixing part 104.

The component mounting part 120 is provided with a mounting surface 122 that protrudes outward of the body 102 of the sealing connector 100, and is circular in this example. The component mounting part 120 has a recessed portion 124 that tapers towards an opening 126. As best seen in FIG. 3(b), the openings 108,126 of the membrane fixing part 104 and the component mounting part 120, respectively, extend through to a rear surface of the sealing connector 100. A frustoconical rear portion 112 on the membrane fixing part 104 side protrudes away from the body 102. A frustoconical rear portion 128 on the component mounting part 120 side protrudes away from the body 102. In this example, the sealing connector 100 is made of high-density polyethylene (HDPE). However, in other examples, the sealing connector 100 may be made of a different material, such as polyetheretherketone (PEEK), rubber, silicone, ethylene propylene diene monomer (EPDM), or nylon, for example.

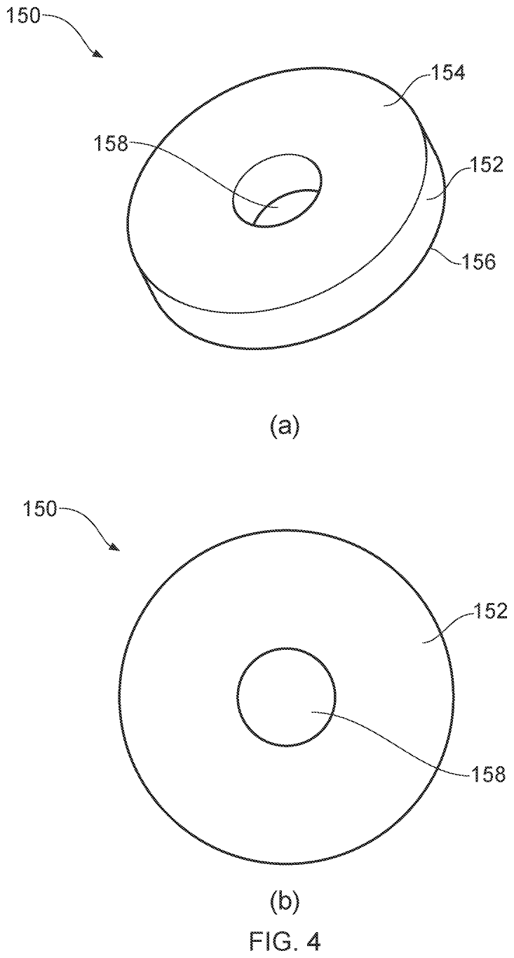

FIG. 4 shows a sealing member 150 that, in use, is located within the recessed portion 106 of the membrane fixing part 104. In this example, the sealing member 150 is a sealing washer. The sealing member 150 has a body 152 with an annular shape extending between a top surface 154 and a bottom surface 156. An opening 158 extends through top surface 154, the body 152 and the bottom surface 156. In this example, the sealing member 150 is formed of rubber. However, in other examples, the sealing connector 100 may be made of a different material, such as polyetheretherketone (PEEK), silicone, EPDM, or nylon, for example.

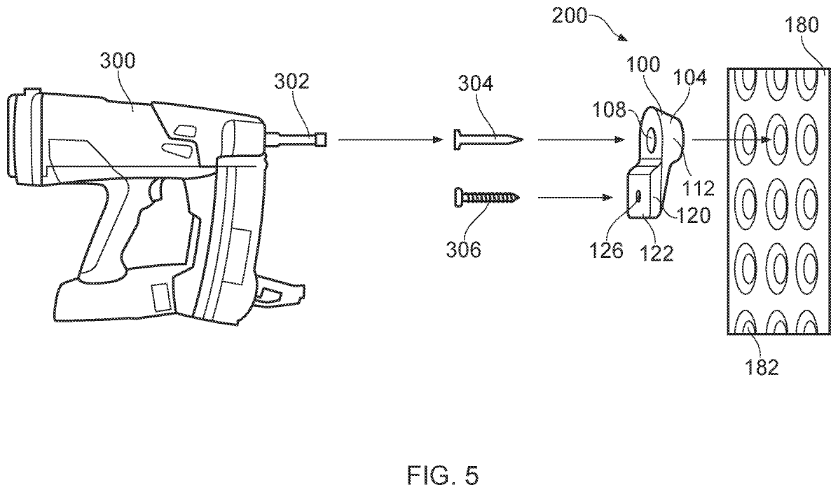

FIG. 5 illustrates how a sealing connector 100 is used to mount a membrane 180 to a wall (i.e. structure), and subsequently attach a bracket (i.e. component) to the sealing connector 100. In the arrangement shown in FIG. 5, the membrane fixing part 104 and the component mounting part 120 of the sealing connector 100 are modified from previously described with reference to FIG. 3. However, the function of the sealing connector 100 remains the same. The membrane fixing part 104 does not have the previously described recessed portion 106. The opening 108 is instead provided extending between a front surface and rear surface of the membrane fixing part 104. The mounting surface 122 of the component mounting part 120 has a square shape instead of the previously described circular shape. The rear surface of the component mounting part 120 does not have the previously described frustoconical rear portion 128. Instead, the rear surface of the component mounting part 120 tapers downward from the frustoconical rear portion 112 of the membrane fixing part 104.

The membrane 180 has a front surface that is arranged to face the sealing connector 100. The membrane 180 has a rear surface that is arranged to face the wall. Recesses 182 are formed in the front surface of the membrane 180. In this example, the front surface of the membrane 180 is provided with an array of recesses 182. The recesses 182 of the array of recesses are equidistantly spaced about the front surface. The recesses 182 may be arranged in aligned rows (i.e. in the horizontal direction). The recesses 182 may alternatively or additionally be arranged in aligned columns (i.e. in the vertical direction). In this example, the membrane 180 is made of HDPE. However, in other examples, the membrane 180 may be made of a different material, such as polyurethane, EPDM, thermoplastic, polyvinyl chloride (PVC) or polycarbonate (PC), for example.

Different arrangements of the recesses 182 in the membrane 180 are envisaged. For example, the array of recesses may be arranged to include a plurality of rows and columns. The number of rows and columns may be the same. Each recess within one or more columns of recesses may be aligned, for example along the plane of the front surface in a vertical direction. In addition or alternatively, each recess within one or more rows of recesses may be aligned, for example along the plane of the front surface in a horizontal direction.

During assembly, the membrane 180 is placed onto the face of a structure, which in this example is a concrete wall. The membrane fixing part 104 of the sealing connector 100 is inserted into a recess 182 of the membrane 180, and affixed to the concrete wall using a nail 304, that is nailed in place using a nailer 300. In this example, a sealing member 150 is held within the recessed portion of the membrane fixing part 104. During assembly, the nail 304 is inserted into a nailing head 302 of a nailer 300, and fired through the sealing member 150, through opening 108 of the membrane fixing part 104, through the membrane 180 and into the concrete wall. This holds the sealing connector 100 in place relative to the concrete wall, with the membrane 180 between the sealing connector 100 and the concrete wall. When inserted, the head of the nail 304 presses the sealing connector 100 against the membrane. The sealing member 150 provides sealing around the puncture hole formed by the nail 304, as it is pushed against the membrane 180. In addition, the sealing member 150 seals the opening 108 that the nail 304 passes through. The pressure of the nail 304 acting against the sealing member 150 improves sealing. When the membrane fixing part 104 is nailed to the structure in this way, the sealing connector 100 is held in place by the nail 304, so that subsequently the user doing the installation does not need to hold onto the sealing connector 100.

The shape of the membrane fixing part 104 corresponds to the shape of the recesses 182 of the membrane 180. In this example, the shape of the membrane fixing part 104 and the recesses of the membrane 180 are frustoconical. To prevent the ingress of water to the inside of the concrete wall, the membrane fixing part 104 seals against the membrane 180. To further improve the sealing properties of the sealing connector 100, the membrane fixing part 104 of the sealing connector 100 is resiliently deformable against the membrane 180 to minimise the gaps between the connector 100 and the membrane 180. After the sealing connector 100 is fixed in place with the nail 304, a further component such as a bracket is mounted to the component fixing part 120 of the sealing connector 100 and held in place with a screw 306. The screw 306 is inserted such that it does not pierce the membrane 180. For example, the screw 306 may be inserted into the component fixing part 120 of the sealing connector 100 such that the end of the screw 306 does not extend beyond the component mounting part 120. The screw 306 may be inserted into the sealing connector 100 such that the screw 306 does not extend beyond any part of the sealing connector 100, and into the membrane 180.

Although in this example, the sealing connector 100 is used to mount a bracket to a wall, is it envisaged that the sealing connector 100 may be used to mount a different component such as a clip, a wall tie, or another fastener, for example. Although in this example, the sealing connector 100 is used to mount a component to a concrete wall, it is envisaged that the sealing connector 100 may be used to mount a component into a different structure, for example a panel, brick wall or any other structure.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

1-15. (canceled)

16. A sealing connector for mounting a component and a membrane to a structure, the sealing connector comprising:
a membrane fixing portion defining an opening sized such that a shaft of a nail can extend through the opening and through the membrane and then into the structure, and
a component mounting portion connected to and extending from the membrane fixing portion and configured to be connected to the membrane.

17. The sealing connector of claim 16, wherein the membrane fixing portion is configured to seal against the membrane.

18. The sealing connector of claim 17, wherein the membrane fixing portion is resiliently deformable against the membrane.

19. The sealing connector of claim 16, wherein the membrane fixing portion includes a sealing member.

20. The sealing connector of claim 19, wherein the sealing member is on a rear portion of the membrane fixing portion.

21. The sealing connector of claim 20, wherein at least part of the membrane fixing portion is shaped and sized to correspond to a recess of the membrane.

22. The sealing connector of claim 16, wherein a rear part of the membrane fixing portion has a frustoconical shape.

23. The sealing connector of claim 16, wherein a rear part of the membrane fixing has a tapered profile.

24. The sealing connector of claim 16, wherein the membrane fixing portion includes a recessed surface configured to receive a sealing washer.

25. A sealing connector assembly for mounting a component to a structure, the sealing connector assembly comprising:
a membrane; and
a sealing connector including:
a membrane fixing portion defining an opening sized such that a shaft of a nail can extend through the opening and through the membrane and then into the structure, and
a component mounting portion connected to and extending from the membrane fixing portion and configured to be connected to the membrane.

26. The sealing connector assembly of claim 25, wherein the membrane includes a front surface arranged to face the sealing connector, and a rear surface arranged to face the structure, and at least one recess formed in the front surface, the recess being shaped to receive part of the membrane fixing portion of the sealing connector.

27. The sealing connector assembly of claim 25, wherein the membrane defines an array of recesses.

28. The sealing connector assembly of claim 27, wherein one of the recesses of the array of recesses is aligned with an adjacent recess along a plane of the front surface in a vertical direction.

29. The sealing connector assembly of claim 27, wherein one of the recesses of the array of recesses is aligned with an adjacent recess along a plane of the front surface in a horizontal direction.
